(19) United States
(12) Patent Application Publication
(10) Pub. No.: US 2017/0272724 A1
(43) Pub. Date: Sep. 21, 2017

(54) APPARATUS AND METHOD FOR MULTI-VIEW STEREO

(71) Applicant: ELECTRONICS AND TELECOMMUNICATIONS RESEARCH INSTITUTE, Daejeon-si (KR)

(72) Inventor: Han Shin LIM, Daejeon-si (KR)

(21) Appl. No.: 15/397,853

(22) Filed: Jan. 4, 2017

(30) Foreign Application Priority Data
Mar. 17, 2016 (KR) 10-2016-0032259

(51) Int. Cl. H04N 13/00; G06K 9/46

(52) U.S. Cl. CPC H04N 13/0022; H04N 13/0037; H04N 13/0059; G06K 9/4604

(57) ABSTRACT

An apparatus for multi-view stereo includes: an initial dense depth map generator to generate an initial dense depth map based on color information and mesh information from a sparse depth map; and a dense depth map improver to regenerate a dense depth map from a sparse depth map where points are added to the sparse depth map.

### CROSS-REFERENCE TO RELATED APPLICATION(S)

This application claims priority to Korean Patent Application No. 10-2016-0032259, filed Mar. 17, 2016, in the Korean Intellectual Property Office, the entire disclosure of which is incorporated herein by reference for all purposes.

### BACKGROUND

1. Field

The following description relates to a three-dimensional modelling technology, and specifically, to an apparatus and method for multi-view stereo to acquire a dense depth map of multi-view images.

2. Description of the Related Art

Recently, a technology of reconstructing and modelling a three-dimensional structure of an object from a color image and a depth image is being actively developed. In order to perform an operation of more precisely reconstructing and modelling the three-dimensional structure, a task of generating a more precise and dense point cloud is needed. One of the core technologies for acquiring such a precise and dense point cloud is a multi-view stereo method.

In generating a three-dimensional point cloud through a multi-view stereo method, one of the most essential content for improving an accuracy of a point cloud is to generate an accurate and dense depth map having depth consistency and having a greater accuracy from a sparse depth map that is made by the projection of points existing on three-dimensional space onto a two-dimensional image plane.

### SUMMARY

The following application provides an apparatus and method for multi-view stereo to generate a dense depth map, having depth consistency by predicting and acquiring a depth value of each position on an image plane by using color information of an original image and mesh information thereof from a sparse depth map that is acquired by the projection of points existing on three-dimensional space onto a two-dimensional image plane.

In one general aspect, an apparatus for multi-view stereo includes: an initial dense depth map generator to generate an initial dense depth map based on color information and mesh information from a sparse depth map; and a dense depth map improver to regenerate a dense depth map from a sparse depth map where points are added to the sparse depth map.

The initial dense depth map generator may include: a sparse depth map generator to generate the sparse depth map where points on three-dimensional space are projected onto a two-dimensional image plane; and a dense depth map generator to generate the dense depth map from the sparse depth map based on the color information and the mesh information.

The dense depth map generator may include: a connection node extractor to extract the projected points on the two-dimensional image plane from the sparse depth map; a mesh generator to generate a mesh by connecting the extracted points; and a depth map generator to generate the dense depth map on an image plane corresponding to each color image by using color consistency of an original color image and the mesh information.

The dense depth map improver may include: a depth consistency checker to check consistency of the dense depth map; and a dense depth map modifier to based on the determination in the depth consistency checker, add points to the sparse depth map, re-perform a depth map generation method using color consistency and the mesh information.

The depth consistency checker may place each pixel, existing on an image plane of the dense depth map, as much as a depth value in a position on three-dimensional space; project the 3D point onto a neighboring image plane; in response to a difference between a depth value in a position, where the point is projected onto the neighboring image plane, and a depth value corresponding to the distance between the reprojected 3D point and the focal point of the neighboring image plane, being smaller than a threshold, determine that there is consistency in the depth value of the pixel; and in response to the difference therebetween being greater than the threshold, determine that there is no consistency in the depth value of the pixel.

The dense depth map modifier may include: a connection node adder to based on the checking in the depth consistency checker, add a point to the sparse depth map; a mesh reconfigure to form a mesh comprising pre-existing connection nodes and the added point in the sparse depth map that comprises the added point; and a depth map generator to re-generate the dense depth map by re-performing a depth map generation method using the color consistency and the mesh information.

The connection node adder may based on the depth consistency checking, search for a match point having a reliability with neighboring images among neighboring pixels of a pixel, which has lowest depth consistency, among pixels included in each unit of mesh; acquire a position of the match point on the three-dimensional space from the searched match points; calculate a depth value of the match point; and add the match point as the connection node.

The dense depth map improver may transmit a re-generated dense depth map to the depth consistency checker; and the depth consistency checker may in response to the checking of the consistency of the re-generated dense depth map, depending on whether a consistency value is met, transmit the re-generated dense depth map to the dense depth map modifier, or output a final dense depth map.

In another general aspect, a method for multi-view stereo includes: generating an initial dense depth map based on color information and mesh information from an initial sparse depth map; and regenerating a dense depth map from a sparse depth map where points are added to the initial sparse depth map.

The generating of the initial dense depth map may include: generating the sparse depth map where points on three-dimensional space are projected onto a two-dimensional image plane; and generating the dense depth map from the sparse depth map based on the color information and the mesh information.

The generating of the dense depth map may include: extracting the projected points on the two-dimensional image plane from the sparse depth map; generating a mesh by connecting the extracted points; and generating the dense depth map on an image plane corresponding to each color image by using color consistency of an original color image and the mesh information.

The regenerating of the dense depth map may include: checking an accuracy of the dense depth map and consistency between the dense depth maps; based on the consistency checking, adding a point to the sparse depth map, re-performing a depth map generation method using color consistency and the mesh information, and improving the dense depth map.

The checking of the consistency may include: placing each pixel, existing on an image plane of the dense depth map, as much as a depth value in a position on three-dimensional space;

project the 3D point onto a neighboring image plane; calculating a difference between a depth value in a position, where the 3D point is projected onto the neighboring image plane, and a depth value corresponding to the distance between the reprojected 3D point and the focal point of the neighboring image plane; in response to the difference therebetween being smaller than a threshold, determining that there is consistency in the depth value of the pixel; and in response to the difference therebetween being greater than the threshold, determining that there is no consistency in the depth value of the pixel.

The improving of the dense depth map include: based on the checking in the depth consistency checker, adding a point to the sparse depth map; forming a mesh comprising pre-existing connection nodes and the added point in the sparse depth map that comprises the added point; and re-generating the dense depth map by re-performing a depth map generation method using the color consistency and the mesh information.

The adding of the connection node may include: based on the depth consistency checking determination, searching for a match point having a reliability with neighboring images among neighboring pixels of a pixel, which has lowest depth consistency, among pixels included in each unit of mesh; acquiring a position of the match point on the three-dimensional space from the searched match points; calculating a depth value of the match point; and adding the searched match points as the connection nodes.

The regenerating of the dense depth map may include: in response to the checking of the consistency of the re-generated dense depth map, depending on whether a consistency value is met, repeatedly perform modifying the dense depth map.

Other features and aspects may be apparent from the following detailed description, the drawings, and the claims.

### BRIEF DESCRIPTION OF THE DRAWINGS

FIG. 1 is an exemplary block diagram illustrating a constitution of an apparatus for a multi-view stereo.

FIG. 2 is a block diagram illustrating an initial dense depth map generator according to an exemplary embodiment.

FIG. 3 is a diagram illustrating an example of a sparse depth map that is made by the projection of points existing on three-dimensional space.

FIG. 4 is a diagram illustrating an example of an operation of generating a depth map based on color consistency of an original color image and mesh information thereof

FIG. 5 is a detailed block diagram illustrating a dense depth map improver according to an exemplary embodiment.

FIG. 6 is a diagram illustrating an example of a process of checking depth consistency according to an exemplary embodiment.

FIG. 7 is a diagram illustrating an example of a process of modifying a dense depth map according to an exemplary embodiment.

FIG. 8 is a flowchart illustrating a method for multi-view stereo according to an exemplary embodiment.

FIG. 9 is a flowchart illustrating an operation of generating an initial depth map according to an exemplary embodiment.

FIG. 10 is a flowchart illustrating an operation of re-generating a depth map according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In the following description, a detailed description of known functions and configurations incorporated herein will be omitted when it may obscure the subject matter with unnecessary detail.

Before describing the exemplary embodiments, terms used throughout this specification are defined. These terms are defined in consideration of functions according to exemplary embodiments, and can be varied according to a purpose of a user or manager, or precedent and so on. Therefore, definitions of the terms should be made on the basis of the overall context.

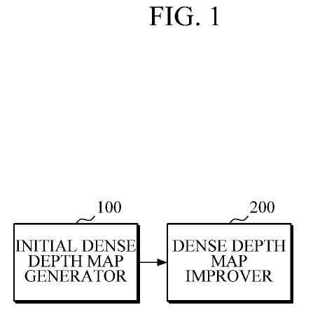

FIG. 1 is an exemplary block diagram illustrating a constitution of an apparatus for a multi-view stereo.

Referring to FIG. 1, an apparatus for multi-view stereo includes an initial dense depth map generator 100 that generates a dense depth map based on color information and mesh from a sparse depth map, and a dense depth map improver 200 that regenerates the dense depth map, to which a point is added, depending on consistency between the dense depth maps.

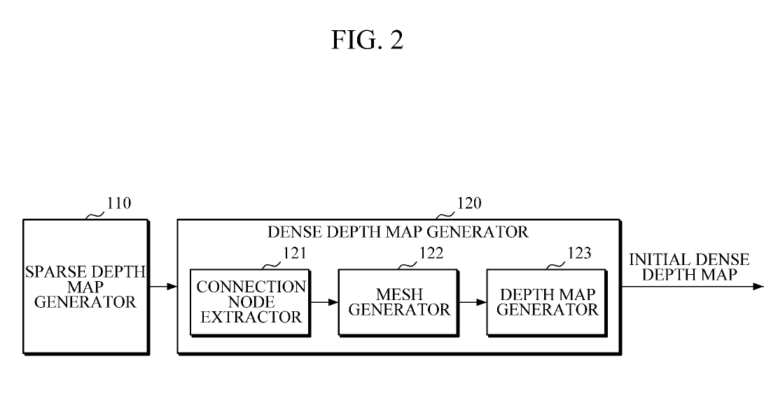

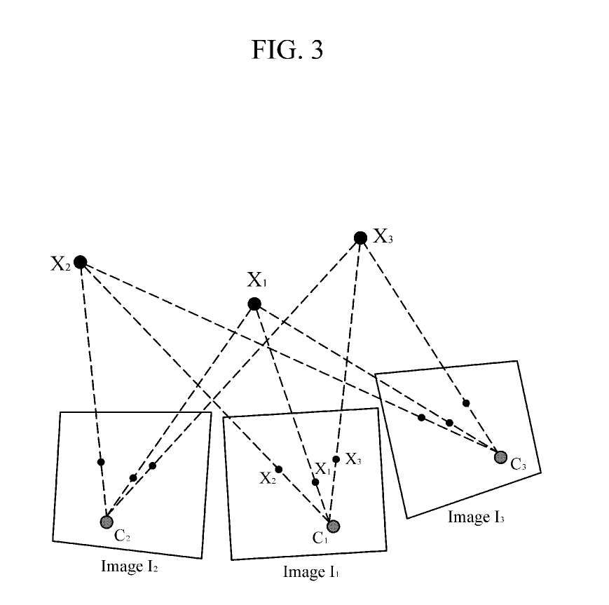

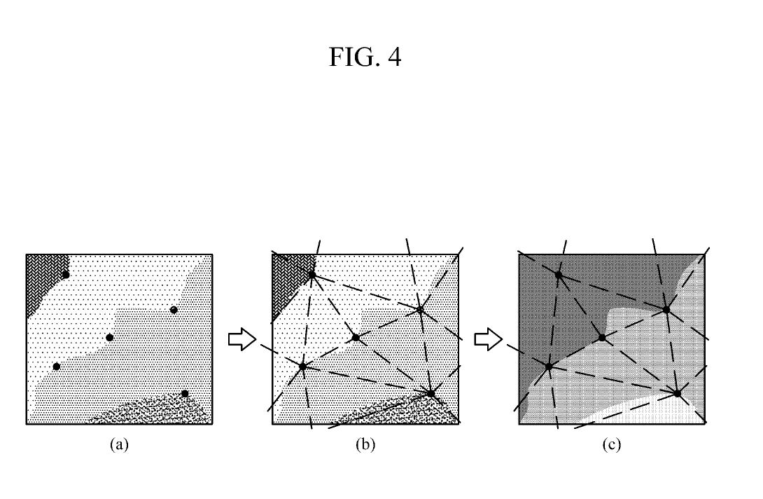

FIG. 2 is a block diagram illustrating an initial dense depth map generator according to an exemplary embodiment; FIG. 3 is a diagram illustrating an example of a sparse depth map that is made by the projection of points existing on three-dimensional space; and FIG. 4 is a diagram illustrating an example of an operation of generating a depth map based on color consistency of an original color image and mesh information thereof.

Referring to FIG.2, an initial dense depth map generator 100 includes a sparse depth map generator 110 and a dense depth map generator 120.

The sparse depth map generator 110 generates a sparse depth map that is made by the projection of points existing on three-dimensional space onto a two-dimensional image plane. Referring to FIG. 3, point X₁ on three-dimensional space is projected as point x₁ on two-dimensional image plane I₁; point X₂ on the three-dimensional space, as point x₂ on the two-dimensional image plane I₂; and point X₃ on the three-dimensional space, as point x₃ on the two-dimensional image plane I₃. C₁ is the focus on the two-dimensional image plane I.

The dense depth map generator 120 generates a dense depth map by using a depth map generation method based on color information and mesh information. Specifically, the dense depth map generator 120 includes a connection node extractor 121, a mesh generator 122, and a depth map generator 123.

The connection node extractor 121 extracts two-dimensional points that are projected onto a sparse depth map, as illustrated in (a) of FIG. 4. The mesh generator 122 generates a mesh having the two-dimensional points as connection nodes, as illustrated in (b) of FIG. 4. The depth map generator 123 generates a dense depth map on an image plane that corresponds to each color image by using a depth map generation method based on color consistency of an original color image and mesh information thereof, as illustrated in (c) of FIG. 4

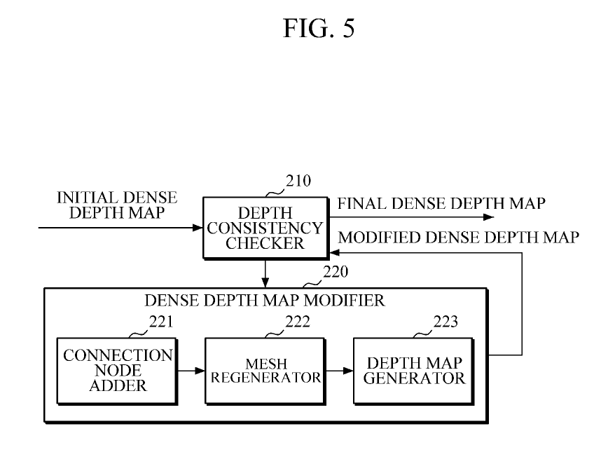

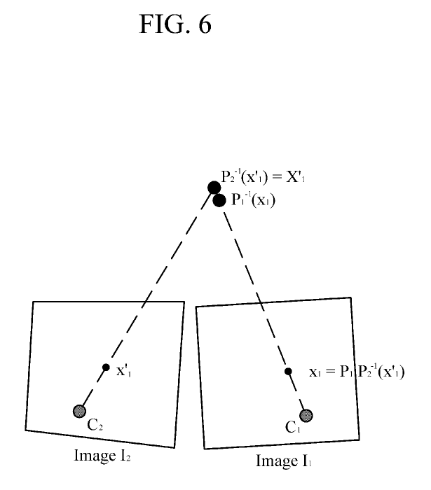

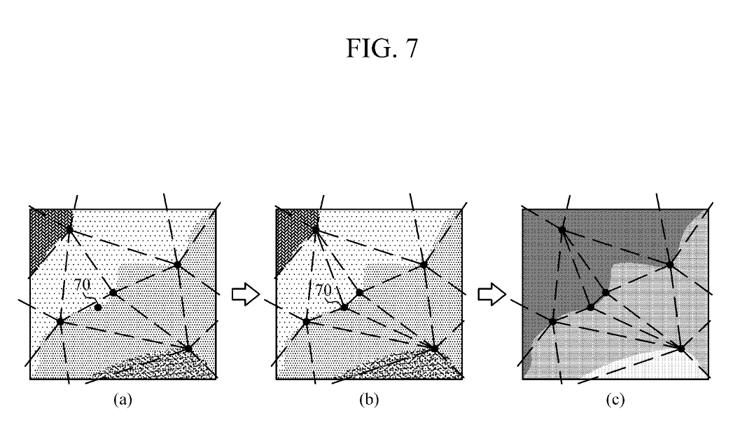

FIG. 5 is a detailed block diagram illustrating a dense depth map improver according to an exemplary embodiment; FIG. 6 is a diagram illustrating an example of a process of checking depth consistency according to an exemplary embodiment; and FIG. 7 is a diagram illustrating an example of a process of modifying a dense depth map according to an exemplary embodiment.

Referring to FIG. 5, a dense depth map improver 200 includes depth consistency checker 210 and a dense depth map modifier 220.

The depth consistency checker 210 performs checking depth consistency (i.e., inter-frame consistency) between dense depth maps. Referring to FIG. 6, each pixel x′₁ on an image plane I₂ of an initial dense depth map is put as much as an obtained depth value in a position on three-dimensional space (P₂⁻¹(x′₁)=V₁), which is then projected to a neighboring image plane I₁ to obtain a position x₁ (x₁=P₁P₂⁻¹(x′₁). Based on the position x₁, a difference between a depth value of x₁ and a depth value of the re-projected point in three-dimensional space is calculated through <Formula 1> shown below.

d(X′₁, P₁⁻¹(x₁)) <Formula 1>

Here, d(A, B) indicates a distance between A and B. If the difference of depth value, calculated through <Formula 1> above, is smaller than a threshold, it is determined that there is consistency; and if the difference is greater than the threshold, it is determined that there is no consistency.

The dense depth map modifier 220 adds a point to a dense depth map depending on the checked result of the depth consistency checker 210, and re-performs a depth map generation method by using color consistency and the mesh information, thereby improving a dense depth map. Specifically, the dense depth map modifier 220 includes a connection node adder 221, a mesh regenerator 222, and a depth map generator 223.

The connection node adder 221 searches for a match point having a reliability with neighboring images among neighboring pixels of a pixel, which has the lowest depth consistency, among pixels included in each unit of mesh, obtains the position of the match point in three-dimensional space from the searched match point between the images, calculates a depth value of the match point as illustrated in (a) of FIG. 7, and adds the match point as a connection node 70. Accordingly, through the results of checking depth consistency among dense depth maps, an accuracy of each depth map and depth consistency between the depth maps may be improved.

The mesh regenerator 222 re-forms the mesh including the pre-existing connection nodes and the added connection nodes in a sparse depth map that includes the added connection nodes 70, as illustrated in (b) of FIG. 7.

As illustrated in (c) of FIG. 7, the depth map generator 223 re-performs the depth map generation method by using the color consistency and the mesh information, and accordingly improves the dense depth map.

The dense depth map improver 200 may repeatedly perform operations of the dense depth map modifier 220 therein until the consistency is met at the depth consistency checker 210.

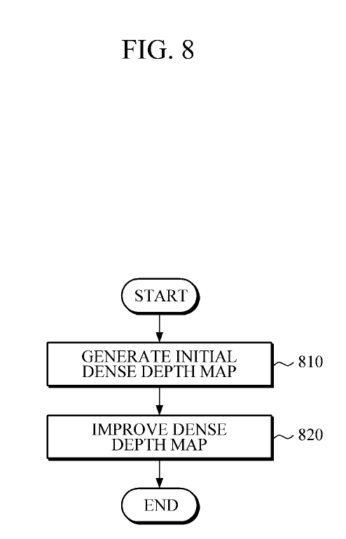

FIG. 8 is a flowchart illustrating a method for multi-view stereo according to an exemplary embodiment.

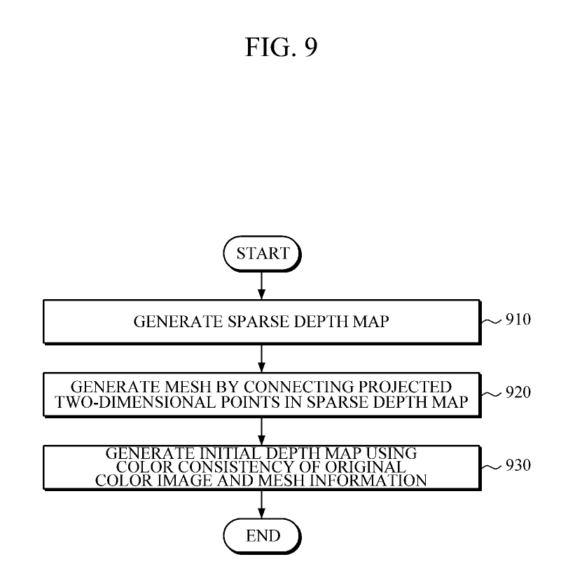

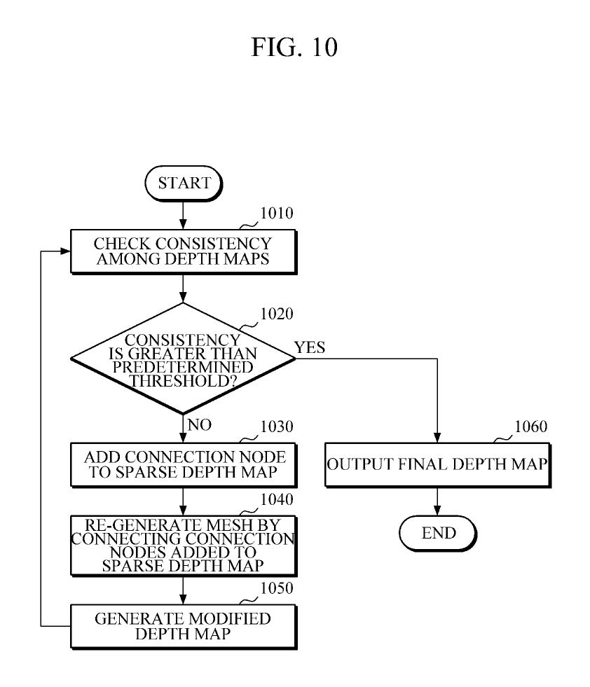

Referring to FIG. 8, an apparatus for multi-view stereo includes: an operation 810 of generating a dense depth map based on color information and mesh information (with reference to FIG. 9); and an operation 820 of regenerating the dense depth map from a sparse depth map, to which points are added, depending on consistency among depth maps (with reference to FIG. 10).

FIG. 9 is a flowchart illustrating an operation of generating an initial depth map according to an exemplary embodiment.

Referring to FIG. 9, an apparatus for multi-view stereo generates a sparse depth map, which is made by the projection of points on three-dimensional space onto two-dimensional image plane, in 910.

The apparatus for multi-view stereo generates a dense depth map by using a depth map generation method based on color information and mesh information in 920 and 930. Specifically, the apparatus generates, in 920, meshes by using two-dimensional points, projected onto the sparse depth map, as illustrated in (a) of FIG. 4, as connection nodes illustrated in (b) of FIG. 4; and generates, in 930, an initial dense depth map on an image plane corresponding to each color image by using a depth map generation method based on color consistency of an original color image and mesh information thereof.

FIG. 10 is a flowchart illustrating an operation of re-generating a depth map according to an exemplary embodiment.

Referring to FIG. 10, an apparatus for multi-view stereo performs checking a depth consistency (inter-frame consistency) between dense depth maps in 1010. That is, the apparatus places each pixel, existing on an image plane of a dense depth map, as much as a depth value in a position on three-dimensional space; re-projects it to a neighboring image plane; and if a difference between a depth value in a position where a point is projected to a neighboring image plane and a depth value corresponding to the distance between the reprojected 3D point and the focal point of the neighboring image plane is smaller than a threshold, the apparatus determines there is consistency, but if the difference is greater than the threshold, the apparatus determines there is no consistency.

In response to the consistency checking determination, if the consistency is not greater than a threshold, the apparatus for multi-view stereo adds points to a dense depth map in 1030. That is, the apparatus searches for a match point having a reliability with neighboring images among neighboring pixels of a pixel, which has the lowest depth consistency, among pixels included in each unit of mesh, obtains the position of the match point in three-dimensional space from the searched match point among the images, calculates a depth value of the match point, and adds the match point as a connection node 70. Accordingly, through the results of checking depth consistency among dense depth maps, an accuracy of each depth map and depth consistency between the depth maps may be improved.

Then, in 1040, the apparatus re-forms the mesh including the pre-existing connection nodes and the added connection nodes in a sparse depth map that includes the added connection nodes 70.

In 1050, the apparatus re-performs a depth map generation method by using the color consistency and the mesh information, and accordingly improves the dense depth map.

Meanwhile, if it is determined, in 1020, that the consistency is greater than a predetermined threshold, the apparatus outputs a final depth map in 1060, and if the consistency is not greater than the predetermined threshold, the apparatus may repeatedly perform operations 1030 to 1050 for modifying a dense depth map.

According to an exemplary embodiment, the use a depth map generation method based on color information and mesh information may help to more precisely generate a dense depth map having a depth consistency among images, thereby making it possible to more exactly recovery and model a 3D structure of an object.

In addition, due to the use of the color consistency and the mesh information, when the small number of points on initial three-dimensional space is given, it makes it possible to generate a dense depth map that is reliable compared to the pre-existing method.

What is claimed is:

1. An apparatus for multi-view stereo, the apparatus comprising:
an initial dense depth map generator configured to generate an initial dense depth map based on color information and mesh information from a sparse depth map; and
a dense depth map improver configured to regenerate a dense depth map from a sparse depth map where points are added to the dense depth map.

2. The apparatus of claim 1, wherein the initial dense depth map generator comprises:
a sparse depth map generator configured to generate the sparse depth map where points on three-dimensional space are projected onto a two-dimensional image plane; and
a dense depth map generator configured to generate the dense depth map from the sparse depth map based on the color information and the mesh information.

3. The apparatus of claim 2, wherein the dense depth map generator comprises:
a connection node extractor configured to extract the projected points on the two-dimensional image plane from the sparse depth map;
a mesh generator configured to generate a mesh by connecting the extracted points; and
a depth map generator configured to generate the dense depth map on an image plane corresponding to each color image by using color consistency of an original color image and the mesh information.

4. The apparatus of claim 1, wherein the dense depth map improver comprises:
a depth consistency checker configured to check consistency of the dense depth map; and
a depth map modifier configured to based on the determination in the depth consistency checker, add points to the sparse depth map, re-perform a depth map generation method using color consistency and the mesh information, and improve the dense depth map.

5. The apparatus of claim 4, wherein the depth consistency checker is configured to:
place each pixel, existing on an image plane of the dense depth map, as much as a depth value in a position on three-dimensional space;
project the 3D point onto a neighboring image plane;
in response to a difference between a depth value in a position, where the 3D point is projected onto the neighboring image plane, and a depth value corresponding to the distance between the reprojected 3D point and the focal point of the neighboring image plane, being smaller than a threshold, determine that there is consistency in the depth value of the pixel; and
in response to the difference therebetween being greater than the threshold, determine that there is no consistency in the depth value of the pixel.

6. The apparatus of claim 4, wherein the dense depth map generator comprises:
a connection node adder configured to based on the checking in the depth consistency checker, add points to the sparse depth map;
a mesh regenerator configured to form a mesh comprising pre-existing connection nodes and the added point in the sparse depth map that comprises the added point; and
a depth map generator configured to re-generate the dense depth map by re-performing a depth map generation method using the color consistency and the mesh information.

7. The apparatus of claim 4, wherein the connection node adder is configured to:
based on the depth consistency checking, search for a match point having a reliability with neighboring images among neighboring pixels of a pixel, which has lowest depth consistency, among pixels included in each unit of mesh;
acquire a position of the match point on the three-dimensional space from the searched match points;
calculate a depth value of the match point; and
add the match point as the connection node.

8. The apparatus of claim 4, wherein:
the dense depth map improver is configured to transmit a re-generated dense depth map to the depth consistency checker; and
the depth consistency checker is configured to in response to the checking of the consistency of the re-generated dense depth map, depending on whether a consistency value is met, transmit the re-generated dense depth map to the dense depth map modifier, or output a final dense depth map.

9. A method for multi-view stereo, the method comprising:
generating an initial dense depth map based on color information and mesh information from an initial sparse depth map; and
regenerating a dense depth map from a sparse depth map where points are added to the initial sparse depth map.

10. The method of claim 9, wherein the generating of the initial dense depth map comprises:
generating the sparse depth map where points on three-dimensional space are projected onto a two-dimensional image plane; and
generating the dense depth map from the sparse depth map based on the color information and the mesh information.

11. The method of claim 10, wherein the generating of the dense depth map comprises:
extracting the projected points on the two-dimensional image plane from the sparse depth map;
generating a mesh by connecting the extracted points; and
generating the dense depth map on an image plane corresponding to each color image by using color consistency of an original color image and the mesh information.

12. The method of claim 9, wherein the regenerating of the dense depth map comprises:
checking a consistency among the dense depth maps;
based on the consistency checking, adding a points to the sparse depth map, re-performing a depth map generation method using color consistency and the mesh information, and improving the dense depth map.

13. The method of claim 12, wherein the checking of the consistency comprises:
placing each pixel, existing on an image plane of the dense depth map, as much as a depth value in a position on three-dimensional space;
projecting the 3D point onto a neighboring image plane;
calculating a difference between a depth value in a position, where the 3D point is projected onto the neighboring image plane, and a depth value corresponding to the distance between the reprojected 3D point and the focal point of the neighboring image plane;
in response to the difference therebetween being smaller than a threshold, determining that there is consistency in the depth value of the pixel; and
in response to the difference therebetween being greater than the threshold, determining that there is no consistency in the depth value of the pixel.

14. The method of claim 12, wherein the improving of the dense depth map comprises:
based on the checking in the depth consistency checker, adding points to the sparse depth map;
forming a mesh comprising pre-existing connection nodes and the added point in the sparse depth map that comprises the added points; and
re-generating the dense depth map by re-performing a depth map generation method using the color consistency and the mesh information.

15. The method of claim 12, wherein the adding of the connection node comprises:
based on the depth consistency checking determination, searching for a match point having a reliability with neighboring images among neighboring pixels of a pixel, which has lowest depth consistency, among pixels included in each unit of mesh;
acquiring a position of the match point on the three-dimensional space from the searched match points;
calculating a depth value of the match point; and
adding the match point as the connection node.

16. The method of claim 12, wherein the regenerating of the dense depth map comprises:
in response to the checking of the consistency of the re-generated dense depth map, depending on whether a consistency value is met, repeatedly perform modifying the dense depth map.
